(19) United States
(12) Patent Application Publication
(10) Pub. No.: US 2013/0192940 A1
(43) Pub. Date: Aug. 1, 2013

(54) GAS SPRING AND DAMPING FORCE GENERATING MECHANISM

(71) Applicant: SHOWA CORPORATION, Gyoda (JP)

(72) Inventors: Kei FURUKAWA, Gyoda (JP); Kazuya INOUE, Gyoda (JP)

(73) Assignee: SHOWA CORPORATION, Gyoda (JP)

(21) Appl. No.: 13/720,282

(22) Filed: Dec. 19, 2012

(30) Foreign Application Priority Data
Jan. 31, 2012 (JP) 2012-018509

(51) Int. Cl. F16F 9/516

(52) U.S. Cl. CPC F16F 9/516
USPC 188/282.1

(57) ABSTRACT

A tubular piston mounted at one end of a rod accommodated inside a cylinder and partitioning the space inside the cylinder includes first groove and second groove recessed from an outer circumferential surface thereof and aligned side by side along a centerline direction of the cylinder, and a communication passage communicating an end face on the side of an opening in the centerline direction of the cylinder with one of the two grooves (second groove) formed on the side of the opening. A rubber-made annular sealing member having an outer circumferential surface contacting an inner circumferential surface of the cylinder is fitted in the second groove. A resin-made restrictor ring that is a C-shaped member fitted in the first groove has an outer circumferential surface positioned closer to the inner circumferential surface of the cylinder than the outer circumferential surface of the piston.

### CROSS-REFERENCE TO RELATED PATENT APPLICATIONS

This application claims the benefit of Japanese Patent Application No. 2012-018509, filed Jan. 31, 2012, which is incorporated by reference herein.

### FIELD OF THE INVENTION

The present invention relates to a gas spring and a damping force generating mechanism.

### BACKGROUND OF THE INVENTION

Gas springs are provided in vehicles between a door and the vehicle body in order to reduce the force necessary for a user to open the door.

The gas spring described in Japanese Patent Application Laid-open No. 2001-343044, for example, contains compressed gas in a cylinder having a piston-side chamber and a rod-chamber, which are communicated with each other through a communicating portion when the piston is in a certain moving range. An O-ring is mounted on the piston. In the extension stroke when the reaction force of gas is applied to the piston in the extending direction, the O-ring closes a flow passage formed in the piston so that the gas in the rod-side chamber flows into the piston-side chamber through the communicating portion. Thus, as the gas spring extends with the piston moving in the extending direction by the reaction force of gas, the fluid resistance of the gas passing through the communicating portion provides extension damping. The gas spring thus assists the operating force applied to open a cover member to which the gas spring is connected. In the compression stroke, on the other hand, the O-ring opens the flow passage in the piston so that the gas in the piston-side chamber flows into the rod-side chamber through both of this flow passage and the communicating portion. The piston can therefore move smoothly in the compression direction as hardly any damping is provided, so that when the operator applies an operating force to close the cover member, the gas spring allows the cover member to be closed quickly.

Typically, an O-ring is mounted on a partition member (piston) partitioning the space inside the cylinder so as to provide a tight seal between the piston and the inner surface of the cylinder in the extension stroke to achieve a high damping force. Even so, when vibration is input from outside to the gas spring, there is a risk that the cylinder and the partition member contact each other. When the cylinder and the partition member are both made of metal, they may produce a metallic noise when contacting each other.

### SUMMARY OF THE INVENTION

An object of the present invention is to provide a gas spring capable of preventing generation of a metallic noise caused by the cylinder and piston contacting each other while achieving a higher damping force.

To achieve the object, the present invention provides a gas spring, including a tubular cylinder, a rod having one end accommodated inside the cylinder and the other end protruding from an opening of the cylinder, and a tubular partition member mounted at the one end of the rod and partitioning a space inside the cylinder. The partition member includes a plurality of grooves recessed from an outer circumferential surface thereof and aligned side by side along a centerline direction of the cylinder, and a communication passage communicating an end face of the partition member on a side of the opening of the cylinder in the centerline direction with one of the plurality of grooves that is formed on the side of the opening. The gas spring further includes a rubber-made annular member fitted in one of the plurality of grooves of the partition member that is communicated with the end face on the side of the opening by the communication passage, and having an outer circumferential surface contacting an inner circumferential surface of the cylinder; and a resin-made fitting member formed in a C-shape and fitted in one of the plurality of grooves of the partition member that is located closer to the one end of the cylinder than the groove in which the annular member is fitted, the fitting member having an outer circumferential surface positioned closer to the inner circumferential surface of the cylinder than the outer circumferential surface of the partition member.

The fitting member should preferably include a recess recessed from the outer circumferential surface thereof, so that the fitting member does not obstruct movement of gas or liquid.

The fitting member should preferably be configured such that it is fitted into the groove of the partition member from a direction orthogonal to the centerline direction, so that the partition member need not be configured dividable in the centerline direction and can be configured simple.

The communication passage of the partition member should preferably be formed by recessing a part of the outer circumferential surface of the partition member. This can prevent generation of an annoying noise that is produced when flows of gas and/or oil from various directions join in the extension stroke.

The partition member should preferably be integrally formed by sintering a metal powder, so that the number of components is reduced, and also the damping force can be generated more accurately.

Viewed from another aspect, the present invention provides a damping force generating mechanism mounted to a rod having one end accommodated inside a cylinder and the other end protruding from an opening of the cylinder. The mechanism includes a tubular partition member mounted at the one end of the rod and partitioning a space inside the cylinder. The partition member includes a plurality of grooves recessed from an outer circumferential surface thereof and aligned side by side along a centerline direction of the cylinder, and a communication passage communicating an end face of the partition member on a side of the opening of the cylinder in the centerline direction with one of the plurality of grooves that is formed on the side of the opening. The mechanism further includes a rubber-made annular member fitted in one of the plurality of grooves of the partition member that is communicated with the end face on the side of the opening by the communication passage, and having an outer circumferential surface contacting an inner circumferential surface of the cylinder; and a resin-made fitting member formed in a C-shape and fitted in one of the plurality of grooves of the partition member that is located closer to the one end of the cylinder than the groove in which the annular member is fitted, the fitting member having an outer circumferential surface positioned closer to the inner circumferential surface of the cylinder than the outer circumferential surface of the partition member.

With the present invention, generation of the metallic noise caused by the cylinder and piston contacting each other can be prevented, while a higher damping force can be achieved.

### BRIEF DESCRIPTION OF THE DRAWINGS

FIG. 1 is a schematic diagram illustrating the configuration of the gas spring according to one embodiment;

FIG. 2A and FIG. 2B are diagrams illustrating the gas spring according to the embodiment applied to a vehicle such as an automobile;

FIG. 3A and FIG. 3B are schematic perspective views illustrating the configuration of a piston, a sealing member, and a restrictor ring;

FIG. 4A and FIG. 4B are cross-sectional views illustrating the sealing member and the restrictor ring fitted on the piston;

FIG. 5A is a diagram illustrating the action of the gas spring in extension stroke, and FIG. 5B is a diagram illustrating the action of the gas spring in compression stroke;

FIG. 6 is a cross-sectional view illustrating a damping force generating part of a gas spring according to a first comparative example;

FIG. 7 is a cross-sectional view illustrating a damping force generating part of a gas spring according to a second comparative example;

FIG. 8 is a cross-sectional view illustrating the gas spring according to the second comparative example in the latter stage of extension stroke where the other end of the cylinder is positioned higher than one end; and

FIG. 9 is a cross-sectional view illustrating the gas spring according to the embodiment in the latter stage of extension stroke where the other end of the cylinder is positioned higher than one end.

### DETAILED DESCRIPTION OF THE INVENTION

### Preferred Embodiments

One embodiment of the present invention will be described in detail with reference to the accompanying drawings.

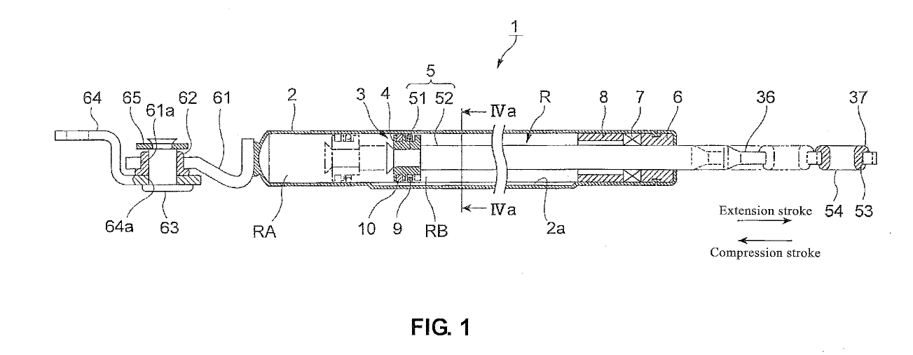

FIG. 1 is a schematic diagram illustrating the configuration of the gas spring 1 according to the embodiment.

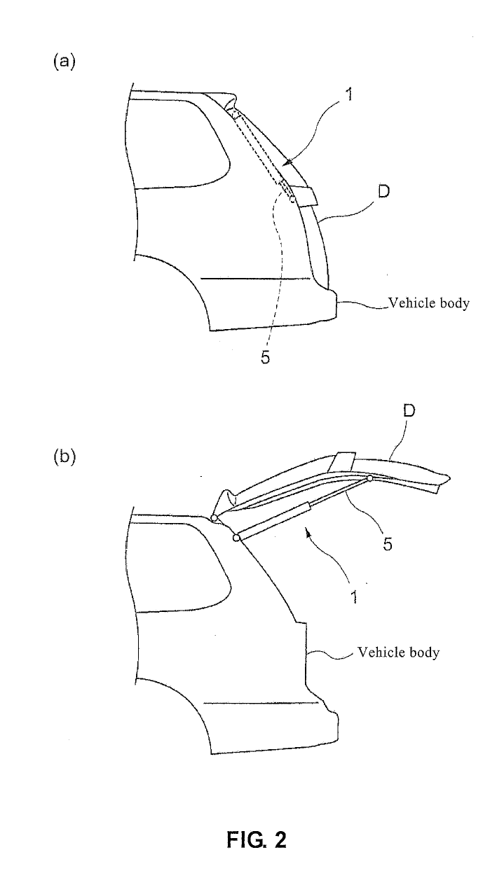

The gas spring 1 is a device mounted to a vehicle between a door D and the vehicle body so as to reduce the force necessary for a user to open the door D (see FIG. 2B).

The gas spring 1 includes a cylinder 2 in which a gas such as air is sealed, and a damping force generating part 3 that generates a damping force inside the cylinder 2.

The cylinder 2 is a thin tubular member made of metal (for example STKM), one end of which in the centerline direction of the tube (hereinafter sometimes simply referred to as “centerline direction”) is closed, while the other end is open. This cylinder 2 includes a cylinder groove 2a extending in the centerline direction formed by denting an inner circumferential surface outward.

The damping force generating part 3 includes a piston 4, which is one example of a partition member that defines a gas chamber R inside the cylinder 2. This damping force generating part 3 will be described in more detail later.

The gas spring 1 further includes a rod 5 with the piston 4 mounted at one end in the centerline direction, the other end protruding to the outside of the cylinder 2, and a cylindrical rod guide 6 made of resin or the like and disposed at the other end of the cylinder 2 for guiding the movement of the rod 5 along the centerline direction. The gas spring 1 further includes a known gas seal 7 disposed at the other end of the cylinder 2 closer to one end thereof than the rod guide for preventing gas leakage from the cylinder 2, and a rebound stopper 8 disposed between the piston 4 and the gas seal 7 to secure an appropriate space between the piston 4 and the gas seal 7.

The rod 5 is a columnar member and includes a first columnar part 51 positioned at one end in the centerline direction, and a second columnar part 52 positioned closer to the other end than the first columnar part 51 in the centerline direction and having a larger diameter than the first columnar part 51. The rod 5 is formed with a mounting hole 53, which is a circular through hole, at the other end protruding to the outside of the cylinder 2, and a resin bush 54 is attached to this mounting hole 53. The gas spring 1 is coupled to the door D of the vehicle via this bush 54.

The rebound stopper 8 is a cylindrical resin member having substantially the same outside diameter as the inside diameter of the cylinder 2. The rebound stopper 8 has an inside diameter larger than the outside diameter of the second columnar part 52 of the rod 5 so that it is movable along the centerline direction.

The cylinder 2 contains a small but sufficient amount of oil necessary for lubricating the rod guide 6 and the gas seal 7 and for maintaining good sealing properties.

The gas spring 1 further includes a coupling plate 61 having one end with a mounting hole 61a that is a circular through hole and the other end in the centerline direction secured to the outer side of one end of the cylinder 2, and a bracket 64 connected to this coupling plate 61 via a resin bush 62 and a pin 63 mounted inside the mounting hole 61a. The bracket 64 has a mounting hole 64a, which is a circular through hole, at the other end in the centerline direction, and the pin 63 is inserted in this mounting hole 64a and the bush 62 that is mounted in the mounting hole 61a of the coupling plate 61. The pin 63 is fastened by flanging at the distal end via a disc-like washer 65 interposed at the distal end. Thus the coupling plate 61 secured to the cylinder 2 is connected to the bracket 64 that is mounted to the vehicle body, so that the gas spring 1 is coupled to the vehicle body.

FIG. 2A and FIG. 2B are diagrams illustrating the gas spring 1 according to the embodiment applied to a vehicle such as an automobile. FIG. 2A is a diagram showing the vehicle with the door D closed, and FIG. 2B is a diagram showing the vehicle with the door D opened.

The bracket 64 provided at one end of the cylinder 2 of the gas spring 1 is attached to an upper part of the vehicle body, while the other end of the rod 5 is attached to the door D. Therefore, when the door D is closed, one end of the cylinder 2 is positioned higher than the other end as shown in FIG. 2A. On the other hand, when the door D is opened and as the rod 5 protrudes from the cylinder 2 increasingly, the other end of the cylinder 2 comes to a position higher than one end as shown in FIG. 2B.

Next, the damping force generating part 3 of the gas spring 1 will be described.

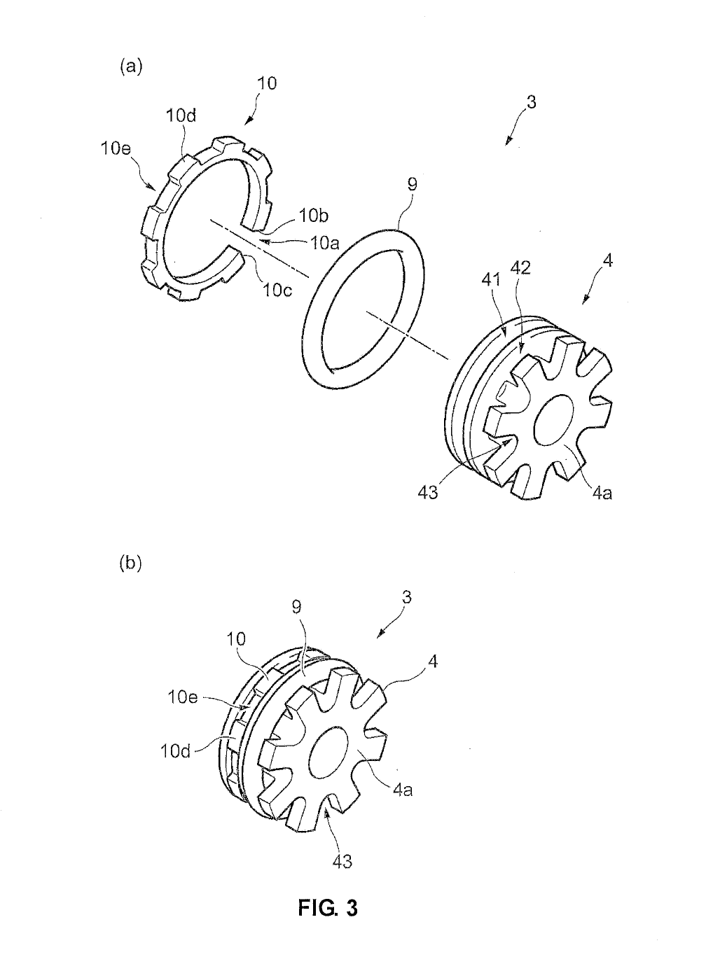

The damping force generating part 3 includes the piston 4 described above (see FIG. 3A), a sealing member 9 such as an O-ring (see FIG. 3A) attached to the piston 4 for hermetically sealing the inner circumferential surface of the cylinder 2, and a restrictor ring 10 (see FIG. 3A) that restricts contact between the inner circumferential surface of the cylinder 2 and the piston 4 even when a force is applied from outside of the cylinder 2.

FIG. 3 and FIG. 3B are schematic perspective views illustrating the configuration of the piston 4, the sealing member 9, and the restrictor ring 10. FIG. 3A is a schematic diagram showing the configuration of each of the piston 4, the sealing member 9, and the restrictor ring 10, while FIG. 3B is a diagram showing them assembled, with the sealing member 9 and the restrictor ring 10 attached to the piston 4.

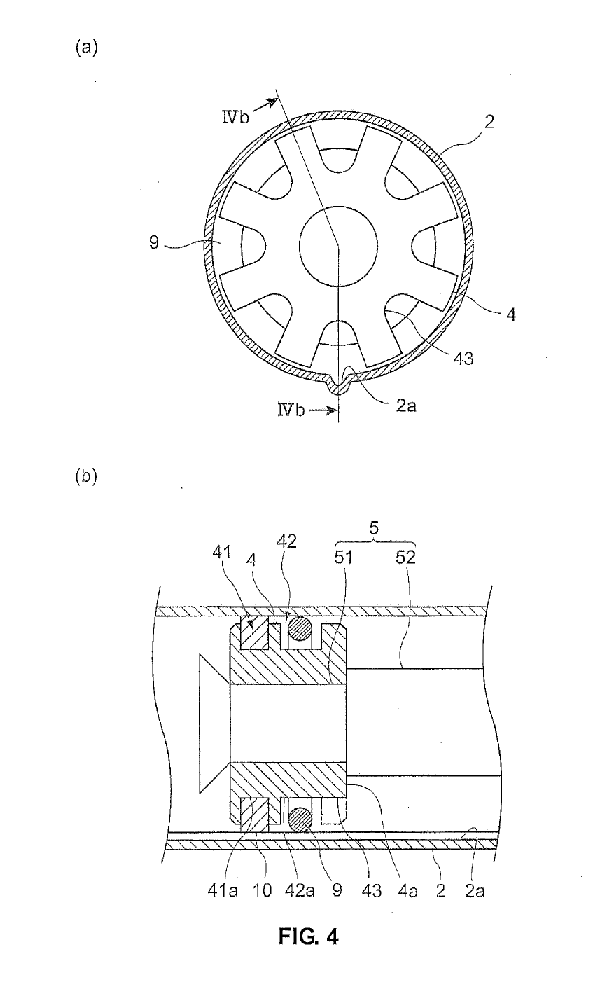

FIG. 4 and FIG. 4B are cross-sectional views illustrating the sealing member 9 and the restrictor ring 10 fitted on the piston 4. FIG. 4A is a cross section along IVa-IVa of FIG. 1, and FIG. 4B is a cross section along IVb-IVb of FIG. 4A.

The piston 4 is basically a cylindrical member, The outer circumferential diameter of the piston 4 is smaller than the inner circumferential diameter of the cylinder 2 so that there is a gap formed between the outer circumferential surface of the piston 4 and the inner circumferential surface of the cylinder 2. The inner circumferential diameter of the piston is equal to or larger than the outer circumferential diameter of the first columnar part 51 of the rod 5 and smaller than the outer circumferential diameter of the second columnar part 52 so that an end face 4a of the piston 4 at the other end in the centerline direction abuts on an end face at one end in the centerline direction of the second columnar part 52 of the rod 5.

The piston 4 is attached to one end of the rod 5 to function as a partition member that divides the gas chamber R inside the cylinder 2 into two parts. Namely, the cylinder 2 is partitioned into one gas chamber RA (see FIG. 1) surrounded by the piston 4 and one end in the centerline direction of the cylinder 2 etc, and another gas chamber RB (see FIG. 1) surrounded by the piston 4, the cylinder 2, and the gas seal 7 etc,

The piston 4 has a plurality of grooves recessed from the outer circumferential surface and aligned side by side along the centerline direction. The piston 4 of this embodiment includes two grooves, i.e., a first groove 41 formed on one end side in the centerline direction and a second groove 42 formed on the other end side. The first groove 41 and the second groove 42 are formed all around with a constant width. The first groove 41 has a quadrilateral cross-sectional shape. The bottom 41a of the first groove 41 may be linear with chamfered corners, or curved in a circular arc shape. Similarly, the second groove 42 has a quadrilateral cross-sectional shape. The bottom 42a of the second groove 42 may be linear with chamfered corners, or curved in a circular arc shape.

The piston 4 includes a plurality of circumferentially equally spaced communication passages 43 that communicate the end face at the other end in the centerline direction of the piston 4 with the second groove 42. The communication passages 43 are formed by recessing the outer circumferential surface inwards (toward the centerline).

The piston 4 is integrally formed by sintering a metal powder.

The sealing member 9 is an annular O-ring having a circular cross-sectional shape, and formed of a material having high resiliency such as rubber. The sealing member 9 has a smaller width than the width of the second groove 42 of the piston 4, so that it is fitted in the second groove 42 of the piston 4 and can move in this position inside the second groove 42 along the centerline direction. The sealing member 9 has an outside diameter such that its outer circumferential surface contacts the inner circumferential surface of the cylinder 2 when the sealing member 9 is fitted in the second groove 42 of the piston 4. Namely, the sealing member 9 has an outside diameter equal to or larger than the inner circumferential diameter of the cylinder 2.

The sealing member 9 has an inside diameter larger than the diameter of the bottom 42a of the second groove 42 so that there is a gap between the inner surface thereof and the bottom 42a of the second groove 42 of the piston 4 when the sealing member 9 is fitted therein. The inside diameter of the sealing member 9 is smaller than the outer circumferential diameter of the piston 4 so that once the sealing member 9 is fitted in the second groove 42 of the piston 4, it is unlikely to come off of the second groove 42.

The restrictor ring 10 is a C-shaped ring. That is, the restrictor ring 10 has a circumferentially cut-off portion 10a, so that one circumferential end 10b does not contact the other circumferential end 10c when no external force is applied to the ring 10. The restrictor ring 10 has a width that is substantially the same as or slightly smaller than that of the first groove 41 of the piston 4, and an inside diameter that is substantially the same as or slightly larger than that of the bottom 41a of the first groove 41 of the piston 4, so that the restrictor ring 10 is fitted in the first groove 41 of the piston 4. The restrictor ring 10 has a quadrilateral cross-sectional shape. The inner circumference of the ring 10 may have a shape that is linear with chamfered corners, or curved in a circular arc, so as to conform to the shape of the bottom 41a of the first groove 41 of the piston 4. The restrictor ring 10 is formed of a resiliently deformable resin so that it can be fitted into the first groove 41 of the piston 4 from a direction orthogonal to the centerline direction by spreading one circumferential end 10b and the other circumferential end 10c apart.

The outer circumferential diameter 10d of the restrictor ring 10 is larger than that of the outer circumferential surface of the piston 4 when the restrictor ring 10 is fitted in the first groove 41 of the piston 4. The outer circumferential diameter 10d of the restrictor ring 10 is equal to or smaller than that of the inner circumferential surface of the cylinder 2 when the restrictor ring 10 is fitted in the first groove 41 of the piston 4 and not subjected to any external force from the outer circumferential side. Alternatively, the outer circumferential diameter 10d of the restrictor ring 10 becomes substantially the same as the inner circumferential surface of the cylinder 2 when the restrictor ring 10 is inserted into the cylinder 2, as it is subjected to a force from the inner circumferential surface of the cylinder 2 and reduces the size of the cut-off portion 10a or the gap between one circumferential end 10b and the other circumferential end 10c. Therefore, when the restrictor ring 10 is fitted on the piston 4 and the piston 4 is inserted in the cylinder 2, the outer circumferential surface 10d of the restrictor ring 10 is positioned closer to the inner circumferential surface of the cylinder 2 than the outer circumferential surface of the piston 4. Accordingly, when vibration is input from outside to the gas spring 1, the restrictor ring 10 prevents the cylinder 2 from contacting the piston 4. This restrictor ring 10 functions as one example of a fitting member.

The restrictor ring 10 further includes circumferentially equally spaced recesses 10e recessed from the outer circumferential surface 10d thereof inwards. The restrictor ring 10 with these recesses 10e therefore does not seal the inner circumferential surface of the cylinder 2 and allows movement of gas and oil from one gas chamber RA to another gas chamber RB and vice versa.

The damping force generating part 3 configured as described above may be mounted to the rod 5 after the components are assembled, i.e., after the sealing member 9 and the restrictor ring 10 are fitted to the piston 4, or, the sealing member 9 and the restrictor ring 10 may be fitted to the piston 4 after the piston 4 is attached to the rod 5. For attaching the piston 4 with the sealing member 9 and/or the restrictor ring 10 fitted thereto, or the piston 4 alone, to the rod 5, the end face 4a at the other end in the centerline direction of the piston 4 is abutted on the end face on one end in the centerline direction of the second columnar part 52 of the rod 5, and the distal end (one end) of the first columnar part 51 of the rod 5 is compressed and deformed, so that the piston 4 is mechanically fastened to the rod 5.

The action of the gas spring 1 configured as described above will be explained.

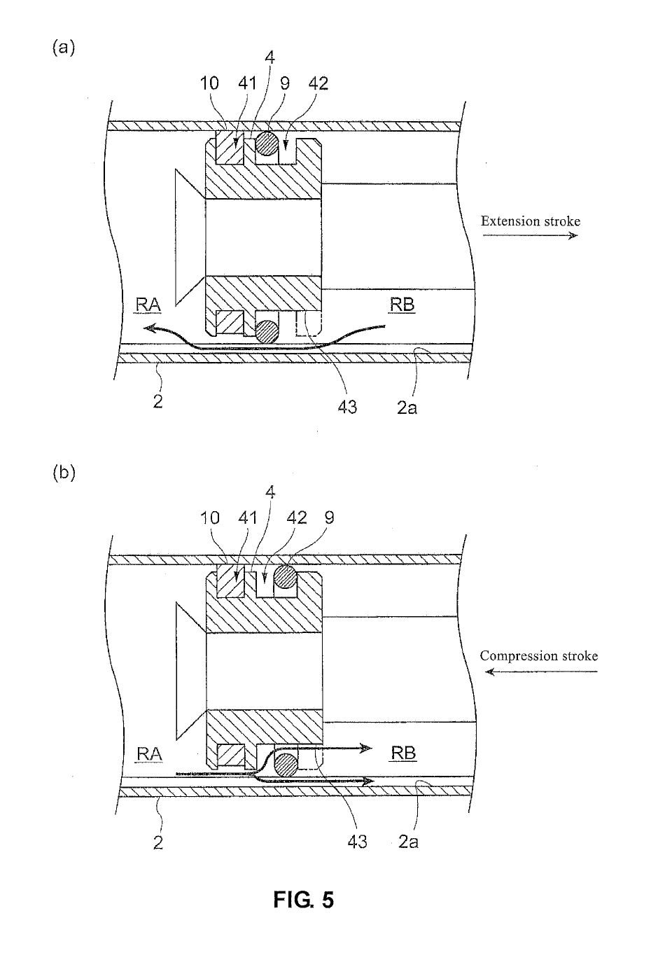

FIG. 5A is a diagram illustrating the action of the gas spring 1 in extension stroke, and FIG. 5B is a diagram illustrating the action of the gas spring 1 in compression stroke.

In the extension stroke, the sealing member 9 fitted in the second groove 42 of the piston 4 is pushed by the gas in the other gas chamber RB that attempts to flow into one gas chamber RA so that it abuts a side face at one end of the second groove 42 of the piston 4 and seals the inner circumferential surface of the cylinder 2 there. Therefore, as indicated by an arrow in FIG. 5A, the gas in the other gas chamber RB flows into one gas chamber RA through the cylinder groove 2a formed in the cylinder 2. It is at this time that the flow resistance generates damping force in the extension direction and thus the speed of the extending rod 5 is controlled.

In the compression stroke, the sealing member 9 is pushed by the gas in one gas chamber RA that attempts to flow into the other gas chamber RB so that it abuts a side face at the other end of the second groove 42 of the piston 4 and seals the inner circumferential surface of the cylinder 2 there. In this state, there is a gap between the sealing member 9 and the side face at one end of the second groove 42 of the piston 4, and therefore, as indicated by arrows in FIG. 5B, the gas in one gas chamber RA flows into the other gas chamber RB through this gap and the plurality of communication passages 43 of the piston 4. The gas in one gas chamber RA flows into the other gas chamber RB also through the cylinder groove 2a formed in the cylinder 2. Accordingly, hardly any damping force is generated so that the compression stroke is fast.

The advantageous effects of the gas spring 1 according to this embodiment configured as described above will be explained in comparison with a gas spring 1 having a different configuration.

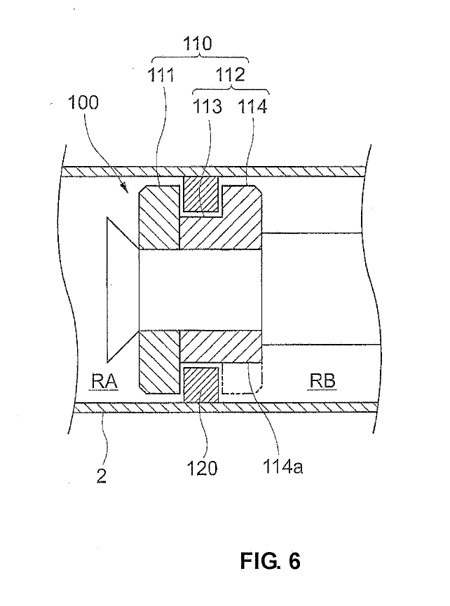

FIG. 6 is a cross-sectional view illustrating a damping force generating part 100 of a gas spring 1 according to a first comparative example.

The gas spring 1 of the first comparative example is different from the gas spring 1 of the embodiment of the invention only in the damping force generating part 100. The difference only will be described below.

The damping force generating part 100 of the gas spring 1 according to the first comparative example includes a piston 110 made up of two components and an annular sealing member 120 made of resin (for example Teflon®) and having a quadrilateral cross-sectional shape. The gas spring 1 according to the first comparative example does not include any component equivalent to the restrictor ring 10 of the damping force generating part 3 according to the embodiment of the invention.

The piston 110 is a metal member made up of a first part 111 located at one end and a second part 112 located at the other end.

The first part 111 is a disc-like member formed with a through hole having a diameter equal to or larger than that of the outer circumferential surface of the first columnar part 51 of the rod 5. The outer circumferential diameter of the first part 111 is smaller than the inner circumferential diameter of the cylinder 2 so that there is a gap formed between the outer circumferential surface of the first part 111 and the inner circumferential surface of the cylinder 2.

The second part 112 includes a first cylindrical portion 113 having a smaller outer circumferential diameter than that of the first part 111 and a second cylindrical portion 114 having an outer circumferential diameter larger than that of the first cylindrical portion 113 and smaller than the inner circumferential diameter of the cylinder 2. Both the first and second cylindrical portions 113 and 114 have an inner cylindrical diameter equal to or larger than the outer circumferential diameter of the first columnar part 51 of the rod 5. The second cylindrical portion 114 includes a recess 114a recessed from the outer circumferential surface such as to extend through the second cylindrical portion 114 from its one end face to the other end face.

The sealing member 120 is made of resin, unlike the sealing member 9 of the damping force generating part 3 according to the embodiment of the invention. It is annular, without a cut-off portion such as the one 10a of the restrictor ring 10 of the damping force generating part 3 according to the embodiment of the invention. Therefore, it cannot be resiliently deformed and fitted into an inwardly recessed groove, such as the second groove 42 of the piston 4 of the damping force generating part 3 according to the embodiment of the invention, from the outer circumferential surface of the cylindrical member, from a direction orthogonal to the centerline direction. This is why the piston 110 of the damping force generating part 100 according to the first comparative example is made up of two parts divided in the axial direction so that the sealing member 120 can be held between these two parts.

The sealing member 120 has a width that is smaller than the distance between the first part 111 of the piston 110 and the second cylindrical portion 114 of the second part 112 so that it is fitted therebetween and can move along the centerline direction in this position.

The gas spring 1 according to the first comparative example configured as described above operates as follows.

In the extension stroke, the sealing member 120 is pushed by the gas in the other gas chamber RB that attempts to flow into one gas chamber RA so that it abuts the first part 111 of the piston 110 and seals the inner circumferential surface of the cylinder 2 there. Therefore, the gas in the other gas chamber RB flows into one gas chamber RA through the cylinder groove 2a formed in the cylinder 2. It is at this time that the flow resistance generates damping force in the extension direction and thus the speed of the extending rod 5 is controlled.

In the compression stroke, the sealing member 120 is pushed by the gas in one gas chamber RA that attempts to flow into the other gas chamber RB so that it abuts the second cylindrical portion 114 of the second part 112 of the piston 110 and seals the inner circumferential surface of the cylinder 2 there. In this state, there is a gap between the sealing member 120 and the first part 111 of the piston 110, and therefore the gas in one gas chamber RA flows into the other gas chamber RB through this gap and the recess 114a in the second part 112 of the piston 110. The gas in one gas chamber RA flows into the other gas chamber RB also through the cylinder groove 2a formed in the cylinder 2. Accordingly, hardly any damping force is generated so that the compression stroke is fast.

Next, the advantages of the gas spring 1 according to the embodiment of the invention over the gas spring 1 according to the first comparative example configured as described above will be explained.

The damping force generating part 3 of the gas spring 1 according to the embodiment of the invention includes a rubber-made sealing member 9 unlike the damping force generating part 100 of the gas spring 1 according to the first comparative example, so that it provides a tighter seal and can exhibit stable sealing performance as compared to the resin-made (e.g., Teflon) sealing member 120. While the piston 110 requires two parts that are dividable in the centerline direction to hold the resin-made sealing member 120, the highly resilient rubber-made sealing member 9 does not require a configuration that is dividable into two parts. The piston 4 therefore has a fewer number of components, so that any axial misalignment of the piston 4 which may lead to a decrease in the damping force is avoided, and also the piston 4 can be made at lower cost.

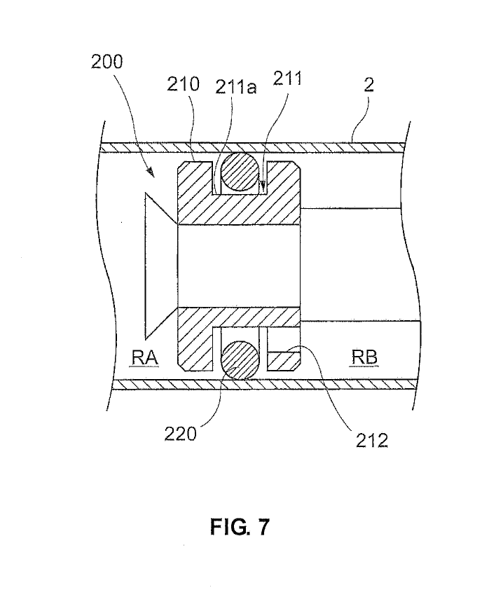

FIG. 7 is a cross-sectional view illustrating a damping force generating part 200 of a gas spring 1 according to a second comparative example.

The gas spring 1 of the second comparative example is different from the gas spring 1 of the embodiment of the invention only in the damping force generating part 3. The difference only will be described below.

The damping force generating part 200 of the gas spring according to the second comparative example includes a metal piston 210 and an annular sealing member 220 made of rubber and having a circular cross-sectional shape. The gas spring 1 according to the second comparative example does not include any component equivalent to the restrictor ring 10 of the damping force generating part 3 according to the embodiment of the invention.

The piston 210 is basically a cylindrical member. The outer circumferential diameter of the piston 210 is smaller than the inner circumferential diameter of the cylinder 2 so that there is a gap formed between the outer circumferential surface of the piston 210 and the inner circumferential surface of the cylinder 2. The inner circumferential diameter of the piston 210 is equal to or larger than the outer circumferential diameter of the first columnar part 51 of the rod 5 and smaller than the outer circumferential diameter of the second columnar part 52. The piston 210 has a groove 211 recessed from the outer circumferential surface thereof and formed all around with a constant width. The groove 211 has a quadrilateral cross-sectional shape. The bottom 211a of the groove 211 may be linear with chamfered corners, or curved in a circular arc shape. The piston 210 further includes a plurality of circumferentially equally spaced through holes 212 extending from the end face at the other end in the centerline direction through to the groove 211.

The sealing member 220 is an annular O-ring having a circular cross-sectional shape and made of a material having high resiliency such as rubber. The sealing member 220 has a smaller width than that of the groove 211 of the piston 210, so that it is fitted in the groove 211 of the piston 210 and can move in this position inside the groove 211 along the centerline direction. The sealing member 220 has an outside diameter such that its outer circumferential surface contacts the inner circumferential surface of the cylinder 2 when the sealing member 220 is fitted in the groove 211 of the piston 210. Namely, the sealing member 220 has an outside diameter equal to or larger than the inner circumferential diameter of the cylinder 2.

The sealing member 220 has an inside diameter larger than the diameter of the bottom 211a of the groove 211 so that there is a gap between the inner circumferential surface thereof and the bottom 211a of the groove 211 of the piston 210 when the sealing member 220 is fitted therein. The inside diameter of the sealing member 220 is smaller than the outer circumferential diameter of the piston 210 so that once the sealing member 220 is fitted in the groove 211 of the piston 210, it is unlikely to come off of the groove 211.

The gas spring 1 according to the second comparative example configured as described above operates as follows.

In the extension stroke, the sealing member 220 fitted in the groove 211 of the piston 210 is pushed by the gas in the other gas chamber RB that attempts to flow into one gas chamber RA so that it abuts a side face at one end in the groove 211 of the piston 210 and seals the inner circumferential surface of the cylinder 2 there. Therefore, the gas in the other gas chamber RB flows into one gas chamber RA through the cylinder groove 2a formed in the cylinder 2. It is at this time that the flow resistance generates damping force in the extension direction and thus the speed of the extending rod 5 is controlled.

In the compression stroke, the sealing member 220 is pushed by the gas in one gas chamber RA that attempts to flow into the other gas chamber RB so that it abuts a side face at the other end in the groove 211 of the piston 210 and seals the inner circumferential surface of the cylinder 2 there. In this state, there is a gap between the sealing member 220 and the side face at one end in the groove 211 of the piston 210, and therefore the gas in one gas chamber RA flows into the other gas chamber RB through this gap and the plurality of through holes 212 in the piston 210. The gas in one gas chamber RA flows into the other gas chamber RB also through the cylinder groove 2a formed in the cylinder 2. Accordingly, hardly any damping force is generated so that the compression stroke is fast.

Next, the advantages of the gas spring 1 according to the embodiment of the invention over the gas spring 1 according to the second comparative example configured as described above will be explained.

In the gas spring 1 according to the second comparative example, the outer circumferential surface of the sealing member 220 contacts the inner circumferential surface of the cylinder 2 in the position fitted in the groove 211 of the piston 210. However, since this sealing member 220 is made of rubber, it has low rigidity. The inside diameter of the sealing member 220 is larger than the diameter of the bottom 211a of the groove 211 so that there is a gap between the inner circumferential surface of the sealing member 220 and the bottom 211a of the groove 211 of the piston 210, for allowing easy flow of gas in one gas chamber RA into the other gas chamber RB in the compression stroke. Because of this, the sealing member 220 may deform when vibration is input from outside to the gas spring of the second comparative example, causing the metal cylinder 2 to contact the metal piston 210, whereby a metallic noise may be generated.

In contrast, in the gas spring 1 according to the embodiment of the invention, the restrictor ring 10 made of a resin having higher rigidity than rubber is fitted in the first groove 41 of the piston 4, and the outer circumferential surface 10d of the restrictor ring 10 is positioned closer to the inner circumference of the cylinder 2 than the outer circumferential surface of the piston 4. Therefore, even when vibration is input from outside to the gas spring 1 according to the embodiment of the invention, the restrictor ring 10 prevents the metal cylinder 2 from contacting the metal piston by contacting the inner circumferential surface of the cylinder 2, whereby no metallic noise will be generated.

This restrictor ring 10 only need to prevent the cylinder 2 from contacting the piston 4 upon vibration being input from outside to the gas spring 1. As it does not require to have a sealing function as with, for example, the sealing member 120 of the gas spring according to the first comparative example, it need not be made of Teflon, for example, so that a more inexpensive material can be selected for the ring.

Moreover, the gas spring 1 according to the embodiment of the invention is unlikely to produce the sound that is generated in the extension stroke of the gas spring 1 of the second comparative example as oil containing gas passes through the cylinder groove 2a. This will be explained in more detail below.

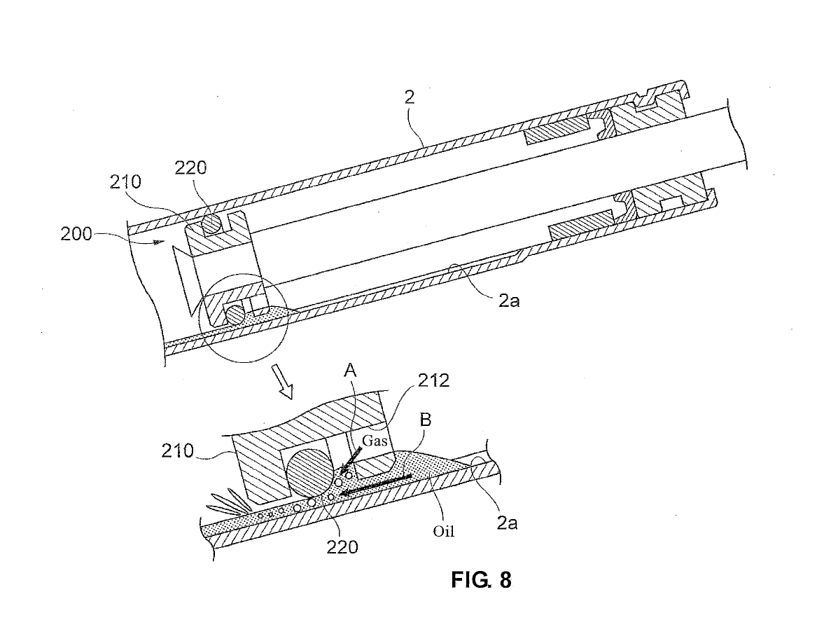

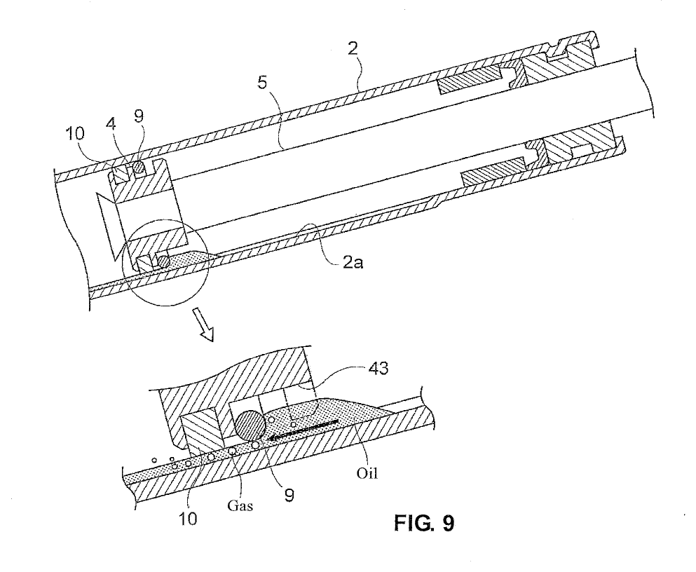

FIG. 8 is a cross-sectional view illustrating the gas spring 1 according to the second comparative example in the latter stage of extension stroke where the other end of the cylinder 2 is positioned higher than one end. FIG. 9 is a cross-sectional view illustrating the gas spring 1 according to the embodiment of the invention in the latter stage of extension stroke where the other end of the cylinder 2 is positioned higher than one end.

In the gas spring 1 according to the second comparative example, the sealing member 220 fitted in the groove 211 of the piston 210 abuts the side face at one end in the groove 211 of the piston 210 and seals the inner circumferential surface of the cylinder 2 in this position. Since there is a gap between the sealing member 220 and the side face at the other end of the groove 211 of the piston 210 in this state, gas and oil that have passed through the through holes 212 of the piston 210 pass through this gap and flow toward the cylinder groove 2a formed in the cylinder 2 (gas and oil move in the direction of arrow A). Oil and gas, mainly oil, also flow through the cylinder groove 2a formed in the cylinder 2 from the other gas chamber RB to one gas chamber RA (oil moves in the direction of arrow B). These flows of gas and oil moving in the direction of arrow A and the oil moving in the direction of arrow B make a sound as they join and as the oil containing gas flows through the cylinder groove 2a.

In contrast, in the gas spring 1 according to the embodiment of the invention, as the communication passages 43 are formed by recessing the outer circumferential surface of the piston 4 inwards, there are no flows of gas and oil corresponding to those flowing in the direction of arrow A in the gas spring 1 of the second comparative example. Therefore, the gas spring 1 according to the embodiment of the invention does not produce a sound that is caused by oil containing gas passing through the cylinder groove 2a.

To prevent the noise caused by the cylinder 2 and the piston 210 contacting each other in the gas spring 1 according to the second comparative example, the piston 210 itself could be made of resin. Alternatively, the piston 210 could be formed by two parts such as, for example, the piston 110 of the gas spring 1 according to the first comparative example, and one of these parts could be made of resin. However, resin used as the material of the piston 210 may suffer a permanent deformation due to constant stress which increases as time passes, and this creep may be accelerated by heat, as a result of which the piston 210 may end up rattling.

Moreover, a resin-made piston, which is not produced through a cutting process, has lower dimensional accuracy than a sintered metal piston, which makes it hard to employ a rubber-made O-ring that tends to undergo large dimensional changes and requires high accuracy for forming a sealing surface.

As described above, the damping force generating part 3 of the gas spring 1 according to the embodiment of the invention includes the piston 4, the rubber-made sealing member 9, and the resin-made restrictor ring 10, so that it can prevent generation of a metallic noise that is caused by the cylinder and piston contacting each other, while achieving a higher damping force. These effects are achieved with a simple configuration, as the damping force generating part 3 is configured with the piston 4 that is integrally formed by sintering, the sealing member 9 that can be fitted to the piston 4 by being resiliently deformed, and the C-shaped restrictor ring 10 that can be formed from an inexpensive resin and can be fitted on the piston 4 from a direction orthogonal to the centerline direction.

### EXPLANATION OF REFERENCE NUMERALS

1: gas spring

2: cylinder

3: damping force generating part

4: piston

5: rod

6: rod guide

7: gas seal

8: rebound stopper

9: sealing member

10: restrictor ring

What is claimed is:

1. A gas spring, comprising:
a tubular cylinder;
a rod having one end accommodated inside said cylinder and the other end protruding from an opening of the cylinder;
a tubular partition member mounted at said one end of said rod and partitioning a space inside said cylinder,
said partition member including a plurality of grooves recessed from an outer circumferential surface thereof and aligned side by side along a centerline direction of the cylinder, and a communication passage communicating an end face of the partition member on a side of said opening of the cylinder in the centerline direction with one of the plurality of grooves that is formed on the side of the opening;
a rubber-made annular member fitted in one of said plurality of grooves of said partition member communicated with the end face on said side of the opening by said communication passage, and having an outer circumferential surface contacting an inner circumferential surface of said cylinder; and
a resin-made fitting member formed in a C-shape and fitted in one of said plurality of grooves of said partition member that is located closer to said one end of said cylinder than the groove in which said annular member is fitted, the fitting member having an outer circumferential surface positioned closer to the inner circumferential surface of the cylinder than the outer circumferential surface of said partition member.

2. The gas spring according to claim 1, wherein said fitting member includes a recess recessed from the outer circumferential surface thereof.

3. The gas spring according to claim 1, wherein said fitting member can be fitted into said groove of said partition member from a direction orthogonal to said centerline direction.

4. The gas spring according to claim 1, wherein said communication passage of said partition member is formed by recessing a part of the outer circumferential surface of the partition member.

5. The gas spring according to claim 1, wherein said partition member is integrally formed by sintering a metal powder.

6. The gas spring according to claim 2, wherein said fitting member can be fitted into said groove of said partition member from a direction orthogonal to said centerline direction.

7. The gas spring according to claim 2, wherein said communication passage of said partition member is formed by recessing a part of the outer circumferential surface of the partition member.

8. The gas spring according to claim 3, wherein said communication passage of said partition member is formed by recessing a part of the outer circumferential surface of the partition member.

9. The gas spring according to claim 2, wherein said partition member is integrally formed by sintering a metal powder.

10. The gas spring according to claim 3, wherein said partition member is integrally formed by sintering a metal powder.

11. The gas spring according to claim 4, wherein said partition member is integrally formed by sintering a metal powder.

12. A damping force generating mechanism mounted to a rod having one end accommodated inside a cylinder and the other end protruding from an opening of the cylinder,
the mechanism comprising:
a tubular partition member mounted at said one end of said rod and partitioning a space inside said cylinder,
said partition member including a plurality of grooves recessed from an outer circumferential surface thereof and aligned side by side along a centerline direction, and a communication passage communicating an end face of the partition member on a side of said opening of the cylinder in the centerline direction with one of the plurality of grooves that is formed on the side of the opening;
a rubber-made annular member fitted in one of said plurality of grooves of said partition member communicated with the end face on said side of the opening by said communication passage, and having an outer circumferential surface contacting an inner circumferential surface of said cylinder; and
a resin-made fitting member formed in a C-shape and fitted in one of said plurality of grooves of said partition member that is located closer to said one end of said cylinder than the groove in which said annular member is fitted, the fitting member having an outer circumferential surface positioned closer to the inner circumferential surface of the cylinder than the outer circumferential surface of said partition member.
